(19) United States
(12) Patent Application Publication
(10) Pub. No.: US 2025/0210676 A1
(43) Pub. Date: Jun. 26, 2025

(54) METHOD FOR OPERATING A FUEL CELL SYSTEM AND FUEL CELL SYSTEM

(71) Applicant: Robert Bosch GmbH, Stuttgart (DE)

(72) Inventors: Felix Schaefer, Sindelfingen (DE); Maxime Carre, Stuttgart (DE); Sebastian Egger, Radolfzell Am Bodensee (DE); Sebastian Schmaderer, Stuttgart (DE)

(21) Appl. No.: 18/848,156

(22) PCT Filed: Apr. 5, 2023
(86) PCT No.: PCT/EP2023/058917

§ 371 Date: Sep. 18, 2024

(30) Foreign Application Priority Data
Apr. 7, 2022 (DE) 10 2022 203 527.5
Sep. 19, 2022 (DE) 10 2022 209 841.2

(51) Int. Cl. H01M 8/04746; H01M 8/0432; H01M 8/0438; H01M 8/0444; H01M 8/04537; H01M 8/1231

(52) U.S. Cl. CPC H01M 8/04753; H01M 8/04328; H01M 8/04388; H01M 8/04447; H01M 8/04611; H01M 8/1231

(57) ABSTRACT

A method for operating a fuel cell system, in particular a high-temperature fuel cell system. In at least one method step of the method, an oxygen-containing fluid is conveyed through at least one fuel cell unit of the fuel cell system for reaction with a fuel, wherein a flow parameter of the oxygen-containing fluid is adjusted according to a power balance of the fuel cell system. In at least one method step of the method, the power balance at a load change of the fuel cell system is partially replaced by an operating characteristic value of the fuel cell system determined in a stationary state of the fuel cell system.

### BACKGROUND INFORMATION

IN a conventional method for operating a fuel cell system, in particular a high-temperature fuel cell system, in at least one method step, an oxygen-containing fluid is conveyed through at least one fuel cell of the fuel cell system for a reaction with a fuel, wherein a flow parameter of the oxygen-containing fluid is adjusted according to a power balance of the fuel cell system.

### SUMMARY

The present invention is based on a method for operating a fuel cell system, in particular a high-temperature fuel cell system, wherein, in at least one method step of the method, an oxygen-containing fluid is conveyed through at least one fuel cell unit of the fuel cell system for a reaction with a fuel, wherein a flow parameter of the oxygen-containing fluid is adjusted according to a power balance of the fuel cell system.

According to an example embodiment of the present invention, it is provided that in at least one method step of the method, the power balance at a load change of the fuel cell system is partially replaced by an operating characteristic value of the fuel cell system ascertained in a stationary state of the fuel cell system. The fuel cell system preferably comprises at least one fluid conveying unit, for example a fan, a compressor or a pump, for conveying the oxygen-containing fluid through the fuel cell unit.

The fuel cell system preferably comprises at least one open-loop or closed-loop control unit for adjustment, in particular closed-loop control, of the flow parameter by means of the fluid conveying unit. The oxygen-containing fluid is preferably air, in particular drawn-in ambient air, or alternatively an industrial gas that consists at least partly, in particular mainly, of oxygen. The oxygen-containing fluid is in particular provided to be reacted by the fuel cell unit with the addition of a fuel, in order to generate electrical energy. The fuel cell unit comprises at least one fuel cell, in particular at least one high-temperature fuel cell, for example at least one molten carbon fuel cell (MCFC) and/or at least one solid oxide fuel cell (SOFC). Preferably, the fuel cell unit comprises a plurality of fuel cells, which are preferably arranged in at least one stack.

According to an example embodiment of the present invention, the open-loop or closed-loop control unit preferably evaluates the power balance in order to adjust the flow parameter. The flow parameter is, for example, a volume flow, a material flow, a mass flow, a particle flow or the like. The power balance preferably adds up energy flows to and from the fuel cell unit, so that they in particular result in zero with the exception of an error term. The error term is preferably less than 20%, preferably less than 10%, particularly preferably less than 5%, of the largest term of the power balance in terms of amount. Preferably, the power balance comprises terms that describe an energy flow due to a transportation of matter through the fuel cell unit, for example in the form of a molar enthalpy flow carried by the fuel, by the oxygen-containing fluid and/or by an exhaust gas. The power balance is particularly dependent on the flow parameter of the oxygen-containing fluid. Preferably, the power balance comprises a term that describes an energy flow carried by the oxygen-containing fluid entering the fuel cell unit. In the fuel cell unit, the oxygen-containing fluid is preferably reacted to form an exhaust gas that is low in oxygen, in particular relative to the oxygen-containing fluid. Preferably, the power balance comprises a term that describes an energy flow carried by the low-oxygen exhaust gas exiting the fuel cell unit. Preferably, the power balance comprises a term that describes an energy flow carried by the fuel entering the fuel cell unit. In the fuel cell unit, fuel is preferably reacted to form an exhaust gas that is low in fuel, particularly relative to the fuel. Preferably, the power balance comprises a term that describes an energy flow carried by the low-fuel exhaust gas exiting the fuel cell unit. Preferably, the power balance comprises a term that comprises an electrical power provided by the fuel cell unit. Optionally, the power balance comprises a term that describes heat losses of the fuel cell unit, in particular through heat conduction and/or heat radiation. Alternatively, the heat losses are added to the error term. Preferably, the error term is set to a constant value, in particular equal to zero or equal to a value ascertained in advance of the method. Preferably, by means of the energy balance, the open-loop or closed-loop control unit ascertains a pre-control value for adjusting the flow parameter. Preferably, the open-loop or closed-loop control unit compensates for an inaccuracy in the power balance due to the error term by closed-loop control of the flow parameter, which flow parameter is added to the pre-control value.

In the stationary state, the electrical power provided by the fuel cell unit, temperatures of the fuel cell system, gas properties of the oxygen-containing fluid and/or the fuel and/or other operating parameters of the fuel cell system are constant, in particular at least within a closed-loop control accuracy of the open-loop or closed-loop control unit. In the case of a load change, for example, the electrical power tapped by the fuel cell unit changes. According to an example embodiment of the present invention, the method is preferably provided to adapt the flow parameter to the load change. Particularly preferably, the method is provided for the purpose of adapting the flow parameter in the case of a rapid load change. In the case of a rapid load change, the temperatures of the fuel cell system, gas properties of the oxygen-containing fluid and/or the fuel remain constant, in particular at least within a closed-loop control accuracy of the open-loop or closed-loop control unit. Preferably, the open-loop or closed-loop control unit updates a pre-control value for adjusting the flow parameter in the case of a load change by means of the energy balance.

According to an example embodiment of the present invention, the operating characteristic value is preferably a number or quantity that the open-loop or closed-loop control unit ascertains in the stationary operating state by partially evaluating the power balance, and stores in a memory of the open-loop or closed-loop control unit. Preferably, when the load changes, the open-loop or closed-loop control unit evaluates a shortened form of the power balance in at least one method step of the method by recourse to the operating characteristic value. With respect to the load change, the power balance comprises dynamic quantities and quasi-constant quantities in particular. Compared to the dynamic quantities, quasi-constant quantities preferably have a smaller time derivative which is preferably more than 5 times smaller, preferably more than 10 times smaller. In particular, an electric current generated by the fuel cell unit and/or the flow parameter of the oxygen-containing fluid is a dynamic quantity with respect to the load change. For example, a composition of the fuel, a fuel electrode inlet temperature of the fuel upon entry into the fuel cell unit, a fuel cell temperature of the fuel cell unit and/or a fuel utilization of the fuel cell unit is a quasi-constant quantity with respect to the load change. The operating characteristic value preferably comprises one, particularly preferably a plurality of the quasi-constant quantities. In particular, the operating characteristic value combines a plurality of quasi-constant quantities into a proportionality factor for at least one dynamic quantity. The open-loop or closed-loop control unit can ascertain the operating characteristic value by evaluating the quasi-constant quantities summarized in the operating characteristic value and/or by evaluating the dynamic quantities linked via the operating characteristic value.

According to an example embodiment of the present invention, preferably, the open-loop or closed-loop control unit regularly and/or as required, prior to ascertaining the flow parameter, checks whether the stored operating characteristic value is still valid. If the operating characteristic value is no longer valid, in particular if a quantity assumed to be quasi-constant has changed by more than a tolerance value, the open-loop or closed-loop control unit evaluates an extended, in particular complete, form of the power balance, preferably without recourse to the operating characteristic value. The extended, in particular complete, form of the power balance preferably comprises an explicit dependency on at least one, in particular all, quantities summarized in the operating indicator. Preferably, the open-loop or closed-loop control unit updates the stored value of the operating characteristic value at least after an evaluation of the extended, in particular complete, form of the power balance.

Due to the embodiment according to the present invention, an advantageously robust and/or advantageously simple method can be provided, by means of which a required value of the flow parameter of the oxygen-containing fluid can be ascertained advantageously precisely. Furthermore, an advantageously high dynamic range can be achieved in a fuel cell system operated using the method.

According to an example embodiment of the present invention, it is also provided that the operating characteristic value eliminates at least two unknowns in the power balance at a load change. The unknowns can be time-dependent quantities and/or unknown constants, for example a composition of the fuel. Preferably, the operating characteristic value comprises at least two quasi-constant quantities as unknowns of the power balance. When ascertaining the flow parameter by means of the operating characteristic value, the open-loop or closed-loop control unit uses the stored value of the operating characteristic value instead of the unknowns. In particular, the open-loop or closed-loop control unit evaluates a calculation rule for the flow parameter that is independent of the eliminated unknowns. When evaluating the extended, in particular complete, form of the power balance without recourse to the operating characteristic value, the open-loop or closed-loop control unit preferably ascertains the unknowns that can be eliminated by the operating characteristic value, in order to ascertain the flow parameter. Due to the embodiment according to the present invention, advantageously few quantities need to be evaluated or detected. In particular, the flow parameter can be ascertained advantageously rapidly or with advantageously little computing power and/or advantageously low memory requirements.

According to an example embodiment of the present invention, it is further proposed that the operating characteristic value summarizes a dependence of the flow parameter on a fuel electrode inlet temperature of the fuel, on a fuel cell temperature of the at least one fuel cell unit, on a hydrogen-to-carbon ratio of the fuel, on an oxygen-to-carbon ratio of the fuel upon entry into the at least one fuel cell unit, and/or on a fuel utilization of the at least one fuel cell. The fuel electrode inlet temperature of the fuel is, in particular, a temperature of the fuel upon entry into the fuel cell unit. The operating characteristic value is preferably a thermoneutral electrical voltage of the fuel cell unit. In particular, the operating characteristic value indicates a ratio of an enthalpy change of the fuel to a number of electrons that are bound by means of oxygen upon a reaction of the fuel in the fuel cell unit. Due to the embodiment according to the present invention, a calculation rule for determining the flow parameter can be kept advantageously compact. In particular, a dependency of the required value of the flow parameter on the fuel can be summarized in the operating characteristic value.

According to an example embodiment of the present invention, it is also proposed that the operating characteristic value be calculated as a moving average. Preferably, the open-loop or closed-loop control unit ascertains a value of the operating characteristic value in the stationary operating state at regular intervals and/or triggered by the receipt of a sensor signal from a sensor unit of the fuel cell system. Preferably, the open-loop or closed-loop control unit stores a plurality of values of the operating characteristic value. Preferably, the open-loop or closed-loop control unit uses an average value of the stored values of the operating characteristic value when ascertaining the flow parameter by means of the operating characteristic value. The average value can be an arithmetic mean or a geometric mean, either weighted or unweighted. Preferably, the open-loop or closed-loop control unit deletes all stored values if the open-loop or closed-loop control unit, due to a change in one of the quasi-constant quantities, evaluates the extended, in particular complete, form of the power balance in order to ascertain the flow parameter. Due to the embodiment according to the present invention, a value of the operating characteristic value can be used which is advantageously unaffected by fluctuations in the operating parameters of the fuel cell system.

According to an example embodiment of the present invention, it is further proposed that in at least one method step of the method, when ascertaining the flow parameter by means of the operating characteristic value, the flow parameter is ascertained on the basis of a target value of a fuel cell temperature, in particular the fuel cell temperature already mentioned, of the at least one fuel cell unit. For example, the term of the power balance that describes the energy flow carried by the low-oxygen exhaust gas exiting the fuel cell unit depends on the fuel cell temperature. An actual value of the fuel cell temperature can be detected on and/or in the fuel cell unit or estimated on the basis of a measured temperature value detected downstream of the fuel cell unit in relation to the low-oxygen exhaust gas. Due to the embodiment according to the present invention, the fuel cell temperature of the fuel cell unit can be adjusted, in particular controlled in a closed-loop manner, by the flow parameter of the oxygen-containing fluid.

Furthermore, according to an example embodiment of the present invention, it is proposed that in at least one method step, the operating characteristic value is kept constant in the case of a load change. Preferably, the operating characteristic value is kept constant for the duration of the load change. In particular, no new value of the operating characteristic value is ascertained during the load change. Preferably, the open-loop or closed-loop control unit checks during the load change whether the operating characteristic value, in particular the last ascertained value of the operating characteristic value or the moving average of the operating characteristic value, is suitable for describing the fuel cell system during the load change and/or in the case of a new value of a load of the fuel cell system. For example, the open-loop or closed-loop control unit examines whether the operating characteristic value is within a specified tolerance band, which is stored in a memory of the open-loop or closed-loop control unit. A maximum value and/or a minimum value of the tolerance band can be a single value and/or a characteristic curve that is dependent, for example, on a quantity detected by the sensor unit, on an actual value and/or a target value of a quantity to be adjusted by the open-loop or closed-loop control unit and/or on the load or load change, in particular the electrical current. Preferably, the open-loop or closed-loop control unit ascertains the flow parameter of the oxygen-containing fluid during and/or after the load change on the basis of the operating characteristic value, which is in particular assessed as suitable. If the open-loop or closed-loop control unit assesses the operating characteristic value as unsuitable, the open-loop or closed-loop control unit preferably evaluates the extended, in particular complete, power balance in order to ascertain the flow parameter during the load change and/or at the new load. Due to the embodiment according to the present invention, the robustness of the method can be further increased. In particular, a risk of instability in the closed-loop control of the flow parameter during the load change can be kept to a minimum.

In addition, according to an example embodiment of the present invention, it is proposed that in at least one method step, the operating characteristic value is changed in the case of a load change according to the load change. Preferably, the operating characteristic value is updated after the load change when a stationary state at the new load is reached. Preferably, the operating characteristic value is updated a plurality of times, in particular regularly, from the time the stationary state is reached at the new load, in particular until the next load change. Preferably, the operating characteristic value is updated, in particular only if the fuel cell system is in a stationary state. Due to the embodiment according to the present invention, the operating characteristic value can be adapted flexibly to different operating states of the fuel cell system. In particular, it is possible to forgo a prior determination of the operating characteristic value in various operating states prior to carrying out the method.

According to an example embodiment of the present invention, it is also proposed that the operating characteristic value is changed as a function of the fuel electrode inlet temperature of the fuel in the case of a load change. Preferably, the open-loop or closed-loop control unit applies a correction function to the stored value of the operating characteristic value, which depends on the fuel electrode inlet temperature. The correction function can be a multiplicative or an additive factor to the stored value of the operating characteristic value. The correction function preferably adds a linear correlation to the fuel electrode inlet temperature to the operating characteristic value. Optionally, the correction function comprises further higher-order correction terms in the fuel electrode inlet temperature. Due to the embodiment according to the present invention, the operating characteristic value can advantageously also be used for ascertaining the flow parameter if the fuel electrode inlet temperature changes in the course of the load change and exceeds a tolerance value for the change in the fuel electrode inlet temperature.

Furthermore, according to an example embodiment of the present invention, it is provided that in at least one method step of the method, at least one measured value of a composition of the fuel is detected, on the basis of which the operating characteristic value is ascertained. The composition of the fuel preferably changes as the fuel passes through the fuel cell system. Preferably, in particular in this sequence, the fuel is fed into the fuel cell system in a fresh state, in particular as natural gas, optionally desulphurized, optionally mixed with the low-fuel exhaust gas, preferably reformed, oxidized in the fuel cell unit, preferably only partially, to form the low-fuel exhaust gas, and then preferably completely oxidized by means of an afterburner. The measured value is preferably detected downstream of the fuel cell unit, in particular in the low-fuel exhaust gas. Alternatively, the measured value or, in addition, a further measured value, which is in particular analogous to the measured value, of the composition of the fuel upstream of the fuel cell unit is detected, preferably in the reformed fuel.

The measured value describes, for example, a concentration, in particular a molar concentration, a volume fraction, a mass fraction, in particular per unit of time, of a substance contained in the fuel at a measuring point of the measured value or a concentration ratio, a volume ratio and/or mass ratio of two or more substances contained in the fuel at the measuring point of the measured value. The measured value is particularly preferably a combustion air ratio of the fuel or a quantity analogous to the combustion air ratio, such as an oxygen deficit, a fuel surplus, in particular a surplus of electrons available for oxidation, or the like. The measured value and/or the further measured value is preferably detected in a stationary operating state of the fuel cell system. Preferably, the open-loop or closed-loop control unit ascertains the operating characteristic on the basis of the measured value and/or the further measured value. Alternatively or additionally, the open-loop or closed-loop control unit ascertains the operating characteristic on the basis of an actual value of the flow parameter, in particular by reversing the calculation rule for ascertaining the flow parameter on the basis of the operating characteristic. The actual value of the flow parameter is ascertained by the open-loop or closed-loop control unit, for example via the extended, in particular complete, form of the power balance. Due to the embodiment according to the present invention, an uncertainty in the determination of the operating characteristic can be advantageously minimized. In particular, an accuracy of the operating characteristic can be maintained independently of an accuracy in the determination of the flow parameter.

According to an example embodiment of the present invention, it is also proposed that the measured value is detected by means of at least one lambda sensor. Particularly preferably, the measured value and/or the further measured value is detected by means of a broadband lambda sensor, in particular in each case. The lambda sensor preferably comprises a Nernst cell and a pump cell, which are connected together in series, wherein a measuring chamber is arranged between the two cell variants. The measuring chamber is preferably delimited by a ceramic diffusion barrier of the lambda sensor. With the aid of a heating element of the lambda sensor, the lambda sensor is optionally kept at a constant temperature, in particular so that an influence of the temperature on a sensor signal, in particular a pump current of the pump cell, of the lambda sensor is eliminated. The lambda sensor preferably has a response time of less than 500 ms, preferably less than 200 ms, particularly preferably less than 100 ms. A voltage signal from the Nernst cell is preferably controlled to a constant value in a closed-loop manner, for example 450 mV, in particular so that a defined combustion air ratio, in particular the stoichiometric combustion air ratio, is present in the measuring chamber. Preferably, the lambda sensor uses the pump cell as a control element to pump oxygen into or out of the measuring chamber depending on the composition of the fuel in the measuring chamber. Optionally, the lambda sensor ascertains a mass flow of oxygen on the basis of the adjusted pump flow of the pump cell, in particular by means of a proportionality factor. Alternatively, the measured value and/or the further measured value is detected by means of a switching-type lambda sensor, in particular in each case. Alternatively, the measured value and/or the further measured value is detected by means of an additional fuel cell to the fuel cell unit, in particular in each case, which additional fuel cell is operated in particular analogously to a lambda sensor. The lambda sensor is preferably arranged upstream, in particular directly upstream, at a fuel inlet of the fuel cell unit or downstream, in particular directly downstream, at an exhaust gas outlet of the fuel cell unit, via which the low-fuel exhaust gas is discharged from the fuel cell unit. Particularly preferably, the fuel cell system comprises a lambda sensor downstream of the fuel cell unit and a further lambda sensor upstream of the fuel cell unit. By the fact that two objects are arranged “directly” upstream or downstream of one another, it should be understood in particular that no other objects which change the composition of the fluid flowing through the objects, for example a reformer, an afterburner or the like, are arranged along the direction of flow between these objects. The objects arranged directly upstream or downstream of one another can be in physical contact with one another or arranged at a distance from one another and fluidically connected, for example by means of fluid lines, a distributor plate or the like. In particular, other objects that do not change the composition of the fluid flowing through the objects, such as a temperature sensor or the like, can be arranged along the direction of flow between the objects arranged directly upstream or downstream of one another. Due to the embodiment according to the present invention, the measured value and/or the further measured value can be detected advantageously simply and cost-effectively. Furthermore, the measured value and/or the further measured value can be detected advantageously rapidly and/or advantageously precisely.

Furthermore, according to an example embodiment of the present invention, it is proposed that at least the majority, in particular all, of the variable quantities from which the operating characteristic value is ascertained are ascertained on the basis of the at least one measured value, in particular the at least one measured value and/or the further measured value.

The open-loop or closed-loop control unit preferably ascertains at least one of the variable quantities of the operating characteristic value by means of a regression function of the measured value and/or the further measured value. The regression function preferably indicates energy carried by the fuel, in particular in the form of a molar enthalpy, into or out of the fuel cell unit on the basis of on the measured value or the further measured value. The regression function can be stored as an analytical expression or as a table in the open-loop or closed-loop control unit. Particularly preferably, a function set of regression functions is stored in the open-loop or closed-loop control unit, which differ from one another in particular by the fuel electrode inlet temperature of the fuel or the fuel cell temperature of the at least one fuel cell unit as parameters. The open-loop or closed-loop control unit ascertains the fuel utilization of the fuel cell unit, preferably on the basis of a difference between the measured value and the further measured value, for ascertaining the operating characteristic value. If the measured value or the further measured value describes the oxygen deficit, the open-loop or closed-loop control unit ascertains the number of available electrons in the fuel, preferably by means of a correlation function on the basis of the measured value and/or the further measured value, for ascertaining the operating characteristic value. Preferably, the correlation function maps a distance of the measured value and/or the further measured value from the stoichiometric combustion air ratio to the number of available electrons in the fuel. Preferably, the regression function is a monotonically decreasing function in the measured value and/or the further measured value. Due to the embodiment according to the present invention, the operating characteristic value can be determined advantageously simply, rapidly and reliably with advantageously little expenditure on measuring devices.

In addition, according to an example embodiment of the present invention, a fuel cell system having at least one fuel cell unit, in particular the fuel cell unit already mentioned, and having at least one open-loop or closed-loop control unit, in particular the open-loop or closed-loop control unit already mentioned, for carrying out a method according to the present invention is proposed. An “open-loop or closed-loop control unit” is in particular to be understood as a unit having at least one electronic open-loop control system. An “electronic open-loop control system” is in particular to be understood as a unit having a processor unit and having a memory, and having an operating program stored in the memory. The fuel cell system preferably comprises the fluid conveying unit. The fuel comprises, for example, hydrogen, methane, ethane, propane and/or another hydrocarbon, in particular an alkane. For example, the fuel is natural gas, a mixture of natural gas and hydrogen, pure hydrogen or the like. The fuel cell system optionally comprises further components for processing and/or post-processing the oxygen-containing fluid, the fuel and/or the exhaust gases. For example, the fuel cell system can comprise a reformer for reforming the fuel, an afterburner for burning fuel residues in the exhaust gases, heat exchangers for preheating the fuel and/or the oxygen-containing fluid, or the like. Preferably, the fuel cell system comprises the sensor unit for detecting the fuel electrode inlet temperature, the fuel cell temperature, an inlet temperature of the oxygen-containing fluid upon entry into the fuel cell unit, an electric current generated by the fuel cell unit and an electric voltage associated with the current, an actual value of the flow parameter and/or further operating parameters of the fuel cell system. In at least one embodiment of the fuel cell system, the sensor unit comprises the lambda sensor and/or the additional lambda sensor. Due to the embodiment according to the present invention, a fuel cell system that comprises an advantageously high dynamic range can be provided.

The method according to the present invention and/or the fuel cell system according to the present invention should not be limited to the application and embodiment described above. In particular, the method according to the present invention and/or the fuel cell system according to the present invention can have a number of individual elements, components and units as well as method steps that differs from the number specified here in order to fulfill a function described herein. In addition, in the case of the value ranges specified in this disclosure, values within the mentioned limits are also to be considered as disclosed and usable as desired.

### BRIEF DESCRIPTION OF THE DRAWINGS

Further advantages result from the following description of the figures. Two exemplary embodiments of the present invention are illustrated in the figures. The figures, and the description contain numerous features in combination. A person skilled in the art will expediently also consider the features individually and combine them to form meaningful further combinations.

FIG. 1 is a schematic view of a fuel cell system according to an example embodiment of the present invention.

FIG. 2 is a schematic flow chart of a method according to an example embodiment of the present invention.

FIG. 3 is a schematic view of a further embodiment of a fuel cell system according to present invention having lambda sensors.

FIG. 4 is a schematic flow chart of a further embodiment of a method according to the present invention with the fuel cell system shown in FIG. 3.

### DETAILED DESCRIPTION OF EXAMPLE EMBODIMENTS

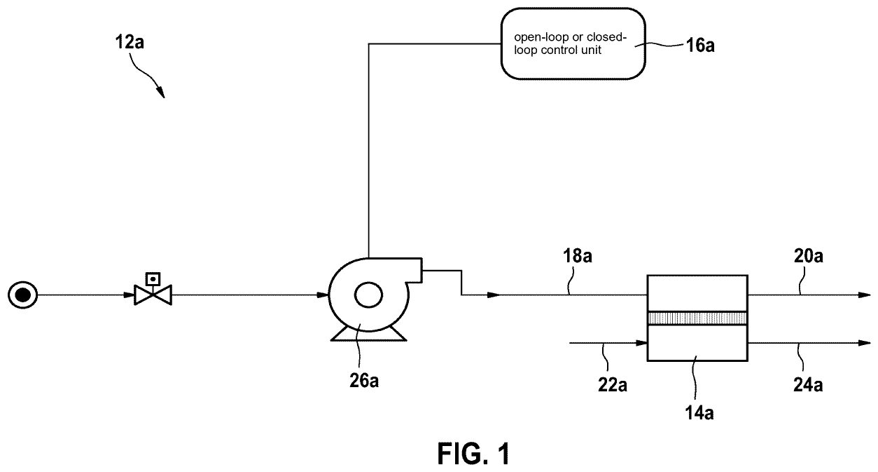

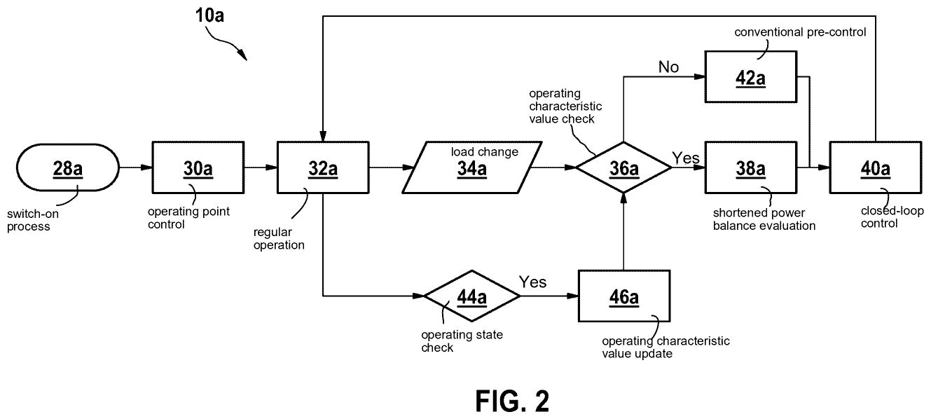

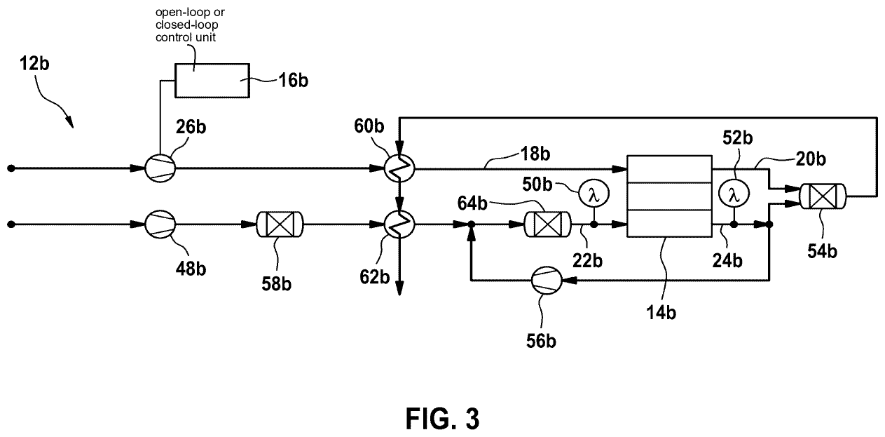

FIG. 1 shows a fuel cell system 12a. The fuel cell system 12a comprises at least one fuel cell unit 14a. The fuel cell unit 14a comprises at least one, in particular a plurality of, fuel cells, in particular high-temperature fuel cells. The fuel cell system 12a preferably comprises at least one fluid supply 18a for supplying an oxygen-containing fluid to the fuel cell unit 14a, in particular to at least one cathode of the fuel cell unit 14a. The oxygen-containing fluid is air, for example. The fuel cell system 12a preferably comprises at least one fuel supply 22a for supplying a fuel to the fuel cell unit 14a, in particular to at least one anode of the fuel cell unit 14a. The fuel cell unit 14a is preferably provided to react the oxygen-containing fluid with the fuel in order to generate an electric current. The fuel cell system 12a preferably comprises an exhaust gas line 20a for discharging a low-oxygen exhaust gas produced from the oxygen-containing fluid. The fuel cell system 12a preferably comprises a further exhaust gas line 24a for discharging a low-fuel exhaust gas produced from the fuel. The fuel cell system 12a preferably comprises a fluid conveying unit 26a for conveying the oxygen-containing fluid through the fluid supply 18a. The fluid conveying unit 26a is preferably designed as a fan, blower, pump or compressor. The fuel cell system 12a comprises at least one open-loop or closed-loop control unit 16a for carrying out a method 10a, which is explained in more detail in FIG. 2. The open-loop or closed-loop control unit 16a is preferably provided to adjust a flow parameter of the oxygen-containing fluid by means of the fluid conveying unit 26a. The fuel cell system 12a is shown here only rudimentarily with the components that are more relevant for the method 10a. The fuel cell system 12a can comprise further components, as shown, for example, in FIG. 3.

FIG. 2 shows the method 10a for operating the fuel cell system 12a. The method 10a preferably comprises a switch-on process 28a, in which the fuel cell system 12a is put into operation. The method 10a preferably comprises an operating point control 30a, in which the open-loop or closed-loop control unit 16a controls an operating point of the fuel cell system 12a. In the operating point control 30a, the fluid conveying unit 26a preferably conveys the oxygen-containing fluid through the fuel cell unit 14a. The open-loop or closed-loop control unit 16a adjusts the flow parameter \dot{n}_{O}_{₂}_{,in} of the oxygen-containing fluid preferably by means of the fluid conveying unit 26a. A target value of the flow parameter \dot{n}_{O}_{₂}_{,in} is ascertained on the basis of a target value of a fuel cell temperature T_{ttc} of the at least one fuel cell unit 14a. The flow parameter \dot{n}_{O}_{₂}_{,in} of the oxygen-containing fluid is adjusted according to a power balance of the fuel cell system 12a. For example, the open-loop or closed-loop control unit 16a ascertains a pre-control value of the flow parameter in the operating point control 30a on the basis of an extended, in particular complete, form of the power balance. In an advantageously simple embodiment, the open-loop or closed-loop control unit 16a ascertains a pre-control value of the flow parameter in the operating point control 30a on the basis of a characteristic curve of the flow parameter stored in advance in the memory of the open-loop or closed-loop control unit, which characteristic curve is preferably dependent on the electric current generated by means of the fuel cell unit 14a. For example, the flow parameter is expressed by the characteristic curve as a linear function, in particular only, of the electric current.

For example, the open-loop or closed-loop control unit 16a evaluates the following stationary power balance:

$${\sum }_{i} {\dot{H}}_{i} - {P}_{e l} + E r r ( {\dot{Q}}_{l o s s} , … ) = 0$$

where \dot{H}ᵢ in each case denotes an enthalpy flow into and out of the fuel cell unit 14a associated with a transport of the oxygen-containing fluid, the fuel and the exhaust gas, Pₑₗ denotes an electrical power generated by the fuel cell unit 14a, and Err(\dot{Q}ₗₒₛₛ, . . . ) denotes an error term.

The electrical power is given by Pₑₗ=Iₑₗ·U_{cells}(Iₑₗ)·N_{cells}, where Iₑₗ is the electrical current generated by the fuel cell unit 14a, U_{cells} is an electrical voltage associated with the generated current Iₑₗ, in particular a total voltage added up over all fuel cells of the fuel cell unit 14a, of the fuel cell unit 14a and N_{cells} denotes the number of fuel cells in the fuel cell unit 14a.

The power balance preferably comprises an energy flow carried by the oxygen-containing fluid toward the fuel cell unit 14a:

$${\dot{H}}_{1} = {h}_{{O}_{2} , i n} ( {T}_{{O}_{2} , i n} ) \cdot {\dot{n}}_{{O}_{2} , i n}$$

where h_{O}_{₂}_{,in} denotes a molar enthalpy of the oxygen-containing fluid upon entry into the fuel cell unit 14a depending on a temperature T_{O}_{₂}_{,in} of the oxygen-containing fluid upon entry into the fuel cell unit 14a and \dot{n}_{O}_{₂}_{,in} denotes the flow parameter. The flow parameter is designed here by way of example as a material flow.

The power balance preferably comprises an energy flow away from the fuel cell unit 14a, carried by the oxygen-depleted exhaust gas:

$${\dot{H}}_{2} = - {h}_{{O}_{2} , out} ( {T}_{ttc} ) \cdot ( {\dot{n}}_{{O}_{2} , i n} - {\dot{n}}_{{O}_{2} , trans} ( {I}_{e l} ) )$$

where h_{O}_{₂}_{,out} denotes a molar enthalpy of the low-oxygen exhaust gas upon exit from the fuel cell unit 14a depending on the fuel cell temperature T_{ttc}, and \dot{n}_{O}_{₂}_{,trans} denotes an oxygen mass flow within the fuel cell unit 14a from the oxygen-containing fluid into the fuel depending on the electric current Iₑₗ.

The power balance preferably comprises an energy flow carried by the fuel towards the fuel cell unit 14a:

$${\dot{H}}_{3} = {h}_{f , i n} ( {T}_{f , i n} , HC , {OC}_{f , i n} ) \cdot {\dot{n}}_{f , i n} ( {I}_{e l} , {FU}_{ttc} , {K}_{{e}^{-} , f , i n} )$$

where h_{f,in} denotes a molar enthalpy of the fuel upon entry into the fuel cell unit 14a and \dot{n}_{f,in} denotes a material flow of the fuel. The molar enthalpy h_{f,in} of the fuel is preferably expressed as a function of a fuel electrode inlet temperature T_{f,in} of the fuel upon entry into the fuel cell unit 14a, a hydrogen-to-carbon ratio HC of the fuel, and an oxygen-to-carbon ratio of the fuel upon entry into the fuel cell unit 14a. The material flow \dot{n}_{f,in} of the fuel is preferably expressed as a function of the electric current Iₑₗ, the fuel utilization FU_{ttc} of the fuel cell unit 14a and a number Kₑ_{^{−}}_{,f,in} of electrons of the fuel per mole of the fuel.

The power balance preferably comprises an energy flow away from the fuel cell unit 14a carried by the low-fuel exhaust gas:

$${\dot{H}}_{4} = - {h}_{f , out} ( {T}_{ttc} , HC , {OC}_{f , out} ) \cdot {\dot{n}}_{f , out} ( {I}_{e l} , {FU}_{ttc} , {K}_{{e}^{-} , f , i n} , \frac{{K}_{C , f , i n}}{{K}_{C , f , out}} )$$

where h_{f,out} denotes a molar enthalpy of the low-fuel exhaust gas upon exit from the fuel cell unit 14a and \dot{n}_{f,out} denotes a material flow of the low-fuel exhaust gas. The molar enthalpy h_{f,out} of the low-fuel exhaust gas is preferably expressed as a function of the fuel cell temperature T_{ttc}, of the hydrogen-to-carbon ratio of the fuel and an oxygen-to-carbon ratio of the low-fuel exhaust gas upon exit from the fuel cell unit 14a. The material flow \dot{n}_{f,out} of the low-fuel exhaust gas is preferably expressed as a function of the electric current Iₑₗ, the fuel utilization FU_{ttc} of the fuel cell unit 14a, the number Kₑ_{^{−}}_{,f,in} of electrons of the fuel per mole of the fuel, and a ratio of a number K_{C,f,in} of carbon atoms in the fuel per mole of fuel to a number K_{C,f,out} of carbon atoms in the low-fuel exhaust gas per mole of that exhaust gas.

The error term Err(\dot{Q}ₗₒₛₛ, . . . ) preferably summarizes all other energy flows to and/or from the fuel cell unit 14a, which in particular are not explicitly ascertained in the course of this embodiment of the method 10a. The error term depends, for example, on heat losses \dot{Q}ₗₒₛₛ of the fuel cell unit 14a, which occur in particular via heat conduction and/or heat radiation. Preferably, the error term Err(\dot{Q}ₗₒₛₛ, . . . ) is set to zero upon ascertaining the pre-control value of the flow parameter \dot{n}_{O}_{₂}_{,in} In an alternative embodiment, the error term Err(\dot{Q}ₗₒₛₛ, . . . ) can be split into further terms, for example in order to explicitly take into account heat losses \dot{Q}ₗₒₛₛ in the power balance.

To ascertain the pre-control value of the flow parameter \dot{n}_{O}_{₂}_{,in}, the following relationships are preferably used in the power balance:

$${\dot{n}}_{{O}_{2} , trans} = \frac{{I}_{e l} {N}_{c e l l s}}{4 \cdot F}$$

$${n}_{f , i n} = \frac{{I}_{e l} {N}_{c e l l s}}{{FU}_{ttc} {K}_{{e}^{-} , f , i n} F}$$

$${OC}_{f , out} = {OC}_{f , i n} + \frac{{K}_{{e}^{-} , f , i n}}{{K}_{C , f , i n}} F {U}_{ttc}$$

where F denotes the Faraday constant. Preferably, the open-loop or closed-loop control unit 16a ascertains the flow parameter \dot{n}_{O}_{₂}_{,in} by means of the following calculation rule derived from the power balance:

$${\dot{n}}_{{O}_{2} , i n} = [ ( {h}_{f , i n} - {h}_{f , out} \frac{{K}_{{e}^{-} , f , i n}}{{K}_{C , f , out}} ) \frac{{I}_{e l} {N}_{c e l l s}}{F {U}_{ttc} {K}_{{e}^{-} , f , i n} F} + {h}_{{O}_{2} , out} \frac{{I}_{e l} {N}_{c e l l s}}{4 \cdot F} - {I}_{e l} {U}_{c e l l s} {N}_{c e l l s} + Err ( {\dot{Q}}_{l o s s} , … ) ] \cdot {( {h}_{{O}_{2} , out} - {h}_{{O}_{2} , i n} )}^{- 1}$$

The method 10a preferably comprises a regular operation 32a. In the regular operation 32a of the method 10a, the oxygen-containing fluid is conveyed by the fluid conveying unit 26a for reaction with the fuel by the at least one fuel cell unit 14a of the fuel cell system 12a. In the regular operation 32a, the open-loop or closed-loop control unit 16a keeps the fuel cell system 12a in a stationary state dependent on the operating point. The method 10a preferably comprises an operating state check 44a. In the operating state check 44a, the open-loop or closed-loop control unit 16a checks whether the state of the fuel cell system 12a is stationary.

The method 10a preferably comprises an operating characteristic value update 46a. The method 10a preferably performs the operating characteristic value update 46a if the fuel cell system 12a is in a stationary state.

In the operating characteristic value update 46a, the open-loop or closed-loop control unit 16a ascertains an operating characteristic value OCV. The operating characteristic value OCV is defined as follows, for example:

$$O C V = ( {h}_{f , i n} - {h}_{f , out} \frac{{K}_{C , f , i n}}{{K}_{C , , f , out}} ) \frac{1}{{FU}_{ttc} {K}_{{e}^{-} , f , i n} F} = f ( {T}_{f , i n} , {T}_{ttc} , HC , {OC}_{f , i n} , {FU}_{ttc} )$$

The operating characteristic value OCV eliminates at least two unknowns in the power balance. The operating characteristic value OCV summarizes a dependence of the flow parameter on the fuel electrode inlet temperature T_{f,in} of the fuel, on the fuel cell temperature T_{ttc} of the at least one fuel cell unit 14a, on the hydrogen-to-carbon ratio HC of the fuel, on the oxygen-to-carbon ratio OC_{f,in} of the fuel upon entry into the at least one fuel cell unit 14a and/or the fuel utilization FU_{ttc} of the at least one fuel cell unit 14a. In particular, the operating characteristic value OCV replaces a dependence of the power balance on a composition, in particular gas quality, of the fuel and its influence on a cooling requirement of the fuel cell unit 14a, in particular by means of the oxygen-containing fluid.

The open-loop or closed-loop control unit 16a preferably ascertains the operating characteristic value OCV using the following calculation rule:

$$OCV = [ {\dot{n}}_{{O}_{2} , i n} ( {h}_{{O}_{2} , out} - {h}_{{O}_{2} , i n} ) - {h}_{{O}_{2} , out} \frac{{I}_{e l} {N}_{c e l l s}}{4 \cdot F} - {I}_{e l} {U}_{c e l l s} {N}_{c e l l s} ] \cdot {( {I}_{e l} {N}_{c e l l s} )}^{- 1}$$

The open-loop or closed-loop control unit 16a preferably stores the ascertained value of the operating characteristic value OCV in the memory of the open-loop or closed-loop control unit 16a. The operating characteristic value OCV is calculated as a moving average.

In the case of a load change 34a, the electrical current Iₑₗ in particular is a time-dependent function. The method 10a preferably comprises an operating characteristic value check 36a. In the operating characteristic value check 36a, the open-loop or closed-loop control unit 16a preferably checks whether the stored value of the operating characteristic value OCV is suitable for describing the fuel cell system 12a under the load change 34a. If the operating characteristic value OCV is unsuitable, the open-loop or closed-loop control unit 16a preferably performs conventional pre-control 42a. If the operating characteristic value OCV is suitable, the open-loop or closed-loop control unit 16a preferably performs a shortened power balance evaluation 38a of the method 10a.

In the conventional pre-control 42a, the open-loop or closed-loop control unit 16a evaluates, for example, the aforementioned characteristic curve of the flow parameter or the above calculation rule for the flow parameter \dot{n}_{O}_{₂}_{,in} which is based in particular on a complete form of the power balance, in particular with the terms specified above.

In the shortened power balance evaluation 38a, the power balance load change 34a of the fuel cell system 12a is partially replaced by the operating characteristic value OCV of the fuel cell system 12a ascertained in the stationary state of the fuel cell system 12a, as a result of which in particular all unknowns of the energy balance are eliminated. For example, the open-loop or closed-loop control unit 16a uses the following calculation rule for the pre-control value of the flow parameter in the shortened power balance evaluation 38a.

$${\dot{n}}_{{O}_{2} , i n} = [ OCV \cdot {I}_{e l} {N}_{c e l l s} + {h}_{{O}_{2} , out} \frac{{I}_{e l} {N}_{c e l l s}}{4 \cdot F} - {I}_{e l} {U}_{c e l l s} {N}_{c e l l s} + E r r ( {\dot{Q}}_{l o s s} , … ) ] \cdot {( {h}_{{O}_{2} , out} - {h}_{{O}_{2} , i n} )}^{- 1}$$

The operating characteristic value OCV is kept constant during the load change 34a and is preferably not updated at least for the duration of the load change 34a. If, during a load change 34a, the fuel cell temperature T_{ttc} changes, the operating characteristic value OCV is changed in the case of a load change 34a as a function of the fuel electrode inlet temperature T_{f,in} of the fuel. In particular, a factor correlating to the fuel electrode inlet temperature T_{f,in} is applied to the stored value of the operating characteristic value OCV.

The method 10a preferably comprises closed-loop control 40a. In the closed-loop control 40a, the open-loop or closed-loop control unit 16a preferably controls the flow parameter \dot{n}_{O}_{₂}_{,in} in a closed-loop manner based on the pre-control value of the flow parameter \dot{n}_{O}_{₂}_{,in} in ascertained by means of the conventional pre-control 42a or the shortened power balance evaluation 38a. With a further run of the operating characteristic value update 46a after the load change 34a, the operating characteristic value OCV is changed according to the load change 34a.

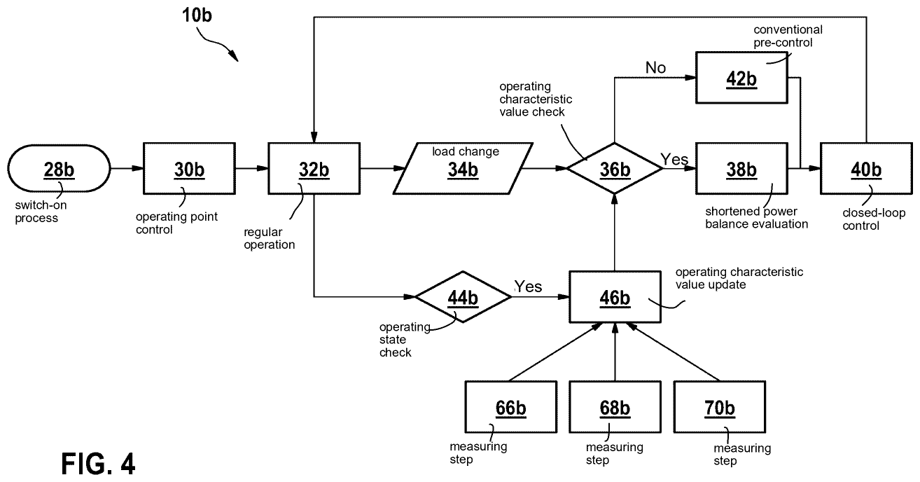

FIG. 3 shows a fuel cell system 12b. The fuel cell system 12b comprises at least one fuel cell unit 14b. The fuel cell unit 14b comprises at least one, in particular a plurality of, fuel cells, in particular high-temperature fuel cells. The fuel cell system 12b preferably comprises at least one fluid supply 18b, a fuel supply 22b, an exhaust gas line 20b, a further exhaust gas line 24b and/or a fluid conveying unit 26b as described further above with respect to FIG. 1. The fuel cell system 12b comprises at least one open-loop or closed-loop control unit 16b for carrying out a method 10b, which is explained in more detail in FIG. 4.

The fuel cell system 12b preferably comprises a fuel conveying unit 48b for conveying a fuel through the fuel supply 22b, the fuel cell unit 14b and the further exhaust gas line 24b. The fuel cell system 12b optionally comprises a desulphurizer 58b for desulphurizing the fuel, in particular downstream of the fuel conveying unit 48b. The fuel cell system 12b preferably comprises a further heat exchanger 62b for transferring heat from an exhaust gas of the fuel cell system 12b to the fuel, in particular downstream of the fuel conveying unit 48b and/or the desulphurizer 58b. The fuel cell system 12b preferably comprises a reformer 64b for reforming the fuel, in particular downstream of the further heat exchanger 62b and upstream of the fuel cell unit 14b. The fuel cell system 12b preferably comprises an afterburner 54b for thermal utilization of fuel residues that are contained in an exhaust gas transported by the further exhaust gas line 24b. The further heat exchanger 62b is preferably arranged downstream of an outlet of the afterburner 54b. The fuel cell system 12b preferably comprises a heat exchanger 60b for transferring heat from the exhaust gas of the fuel cell system 12b, in particular the afterburner 54b, to an oxygen-containing fluid in the fluid supply 18b. Optionally, the fuel cell system 12b comprises a recirculation line for recirculating the exhaust gas carried by the further exhaust gas line 24b into the fuel supply 22b, wherein a feed point of the exhaust gas is preferably arranged upstream of the reformer 64b. The fuel cell system 12b preferably comprises a recirculation conveying unit 56b for conveying the exhaust gas carried by the further exhaust gas line 24b through the recirculation line.

The fuel cell system 12b preferably comprises at least one lambda sensor 52b, which is arranged in the further exhaust gas line 24b or in the recirculation line of the fuel cell system 12b or downstream of a branch of the exhaust gas line 24b into the recirculation line and upstream of the afterburner 54b. The lambda probe 52b is preferably provided for detecting a measured value of a composition of a low-fuel exhaust gas produced by the reaction of the fuel in the fuel cell unit 14b. The fuel cell system 12b preferably comprises at least one further lambda sensor 50b, which is arranged in the fuel supply 22b. The further lambda sensor 50b is preferably arranged downstream of the reformer 64b. The further lambda sensor 50b is preferably provided to detect a further measured value of a composition of the fuel entering the fuel cell unit 14b, in particular reformed fuel.

FIG. 4 shows the method 10b for operating the fuel cell system 12b. The method 10b comprises an operating characteristic value update 46b. The open-loop or closed-loop control unit 16b ascertains the operating characteristic value OCV, preferably using the following calculation rule:

$$O C V = ( {h}_{f , i n} - {h}_{f , out} \frac{{K}_{C , f , i n}}{{K}_{C , , f , out}} ) \frac{1}{F {U}_{ttc} {K}_{{e}^{-} , f , i n}} F$$

wherein all quantities mentioned have already been introduced in the description of FIG. 2. In at least one method step of method 10b, at least one measured value of a composition of the fuel is detected, on the basis of which the operating characteristic value OCV is ascertained. The measured value is detected by means of at least one of the lambda sensors 50b, 52b. At least the majority, in particular all, of the variable quantities from which the operating characteristic value OCV is ascertained are ascertained on the basis of the at least one measured value.

The open-loop or closed-loop control unit 16b preferably ascertains a fuel utilization FU_{ttc} of the fuel cell unit 14b using the following calculation rule:

$$F {U}_{ttc} = \frac{{λ}_{f , out} - {λ}_{f , i n}}{1 - {λ}_{f , i n}}$$

where λ_{f,out} denotes a combustion air ratio of the low-fuel exhaust gas upon exit from the fuel cell unit 14b and λ_{f,in} denotes a combustion air ratio of the fuel upon entry into the fuel cell unit 14b. The method 10b preferably comprises a measuring step 66b, in which the combustion air ratio λ_{f,out} of the low-fuel exhaust gas is preferably detected by the lambda sensor 50b. The method 10b preferably comprises a measuring step 68b, in which the combustion air ratio λ_{f,in} of the fuel upon entry into the fuel cell unit 14b is preferably detected by the further lambda probe 52b.

A molar enthalpy h_{f,in} of the fuel upon entry into the fuel cell unit 14b is ascertained by the open-loop or closed-loop control unit 16b preferably by means of a regression function on the basis of the further measured value, in particular the combustion air ratio λ_{f,in} of the fuel upon entry into the fuel cell unit 14b. Preferably, the open-loop or closed-loop control unit 16b uses a fuel electrode inlet temperature T_{f,in} of the fuel upon entry into the fuel cell unit 14b, as a parameter of the regression function or to select a specific regression function from a set of regression functions of the molar enthalpy h_{f,in} of the fuel upon entry into the fuel cell unit 14b.

The open-loop or closed-loop control unit 16b preferably ascertains a molar enthalpy h_{f,out} of the low-fuel exhaust gas upon exit from the fuel cell unit 14b by means of a further regression function on the basis of the measured value, in particular the combustion air ratio λ_{f,out} of the low-fuel exhaust gas upon exit from the fuel cell unit 14b. Preferably, the open-loop or closed-loop control unit 16b uses a fuel cell temperature T_{ttc} of the fuel cell unit 14b as a parameter of the further regression function or in order to select a specific further regression function from a set of further regression functions of the molar enthalpy h_{f,out} of the low-fuel exhaust gas upon exit from the fuel cell unit 14b. Alternatively, the further regression function maps the combustion air ratio λ_{f,out} of the low-fuel exhaust gas directly based on the product

$${h}_{f , out} \frac{{K}_{C , f , i n}}{{K}_{C , f , out}}$$

of the molar enthalpy h_{f,out} of the low-fuel exhaust gas and a ratio of a molar amount of carbon K_{C,f,in} which enters the fuel cell unit 14b to a molar amount of carbon K_{C,f,out} which exits the fuel cell unit 14b. In an advantageously simple embodiment, the ratio of the molar amounts of carbon K_{C,f,in}/K_{C,f,out} is set equal to 1 or another constant ascertained in advance of the method.

The method 10b preferably comprises a measuring step 70b for detecting a fuel cell temperature T_{ttc}, the fuel electrode inlet temperature T_{f,in} and/or other operating parameters of the fuel cell system 12b.

Preferably, the open-loop or closed-loop control unit 16b ascertains a number Kₑ_{^{−}}_{,f,in} of available electrons in the fuel upon entry into the fuel cell unit 14b, preferably by means of a correlation function depending on the further measured value.

The at least one measured value is optionally corrected by means of a machine learning process, in particular in the sense of a hybrid system. As a result, an advantageously high accuracy of the method 10b can be achieved. The machine learning process is used, for example, to estimate an error c between a real value hₛ and a value h_{λ} measured using the lambda sensor 52b or the other lambda sensor 50b, and thus to improve the latter values, in particular in the form hₛ=h_{λ}+ε. The machine learning process is preferably trained in advance of the method 10b using training data for estimating the error c at various operating points of the fuel cell system 12b. The machine learning process can be set up as a function of at least one measured quantity of at least one of the lambda sensors 50b, 52b such as pump current, pump voltage, temperature and/or Nernst voltage and/or as a function of at least one operating parameter of the fuel cell system 12b, such as a component temperature, a fuel temperature, a pressure of the fuel, a volume flow of the fuel or the like. The error ε is preferably an output quantity on which the machine learning process is trained.

The machine learning process is designed, for example, as a multivariate linear regression, a neural network and/or a Gaussian process.

With respect to further features of the fuel cell system 12b and/or the method 10b, reference is made to FIGS. 1 and 2 and their description.

In particular, the method 10a can also be performed using the fuel cell system 12b, or any component shown in the fuel cell system 12b can also be included in the fuel cell system 10a without adapting the method 10a.

1-12. (canceled)

13. A method for operating a high-temperature fuel cell system, the method comprising the following steps:
conveying an oxygen-containing fluid through at least one fuel cell unit f the fuel cell system for a reaction with a fuel, wherein a flow parameter of the oxygen-containing fluid is adjusted according to a power balance of the fuel cell system; and
partially replacing the power balance at a load change of the fuel cell system by an operating characteristic value of the fuel cell system determined in a stationary state of the fuel cell system.

14. The method according to claim 13, wherein the operating characteristic value eliminates at least two unknowns of the power balance at a load change.

15. The method according to claim 13, wherein the operating characteristic value summarizes a dependence of the flow parameter: (i) on a fuel electrode inlet temperature of the fuel, and/or (ii) on a fuel cell temperature of the at least one fuel cell unit, and/or (iii) on a hydrogen-to-carbon ratio of the fuel, and/or (iv) on an oxygen-to-carbon ratio of the fuel upon entry into the at least one fuel cell unit, and/or (v) on a fuel utilization of the at least one fuel cell unit.

16. The method according to claim 13, wherein the operating characteristic value is ascertained as a moving average.

17. The method according to claim 13, wherein, in at least one method step, upon ascertaining the flow parameter using the operating characteristic value, the flow parameter is ascertained based on a target value of a fuel cell temperature of the at least one fuel cell unit.

18. The method according to claim 13, wherein, in at least one method step, the operating characteristic value is kept constant during a load change.

19. The method according to claim 13, wherein, in at least one method step, the operating characteristic value is changed in the case of a load change according to the load change.

20. The method according to claim 19, wherein the operating characteristic value is changed in the case of a load change as a function of the fuel electrode inlet temperature of the fuel.

21. The method according to claim 13, wherein, in at least one method step, at least one measured value of a composition of the fuel is detected, based on which the operating characteristic value is ascertained.

22. The method according to claim 21, wherein the measured value is detected using at least one lambda sensor.

23. The method according to claim 21, wherein at least the majority of variable quantities from which the operating characteristic value is ascertained are ascertained based on the at least one measured value.

24. A fuel cell system, comprising:
at least one fuel cell unit; and
at least one open-loop or closed-loop control unit for operating a high-temperature fuel cell system, the control unit configured to:
convey an oxygen-containing fluid through at least one fuel cell unit f the fuel cell system for a reaction with a fuel, wherein a flow parameter of the oxygen-containing fluid is adjusted according to a power balance of the fuel cell system, and
partially replace the power balance at a load change of the fuel cell system by an operating characteristic value of the fuel cell system determined in a stationary state of the fuel cell system.
